(19) United States
(12) Patent Application Publication
(10) Pub. No.: US 2025/0388283 A1
(43) Pub. Date: Dec. 25, 2025

(54) WINDSCREEN DEVICE AND STRADDLE-TYPE VEHICLE

(71) Applicant: SUZUKI MOTOR CORPORATION, Hamamatsu-shi (JP)

(72) Inventor: Hikaru KIZU, Hamamatsu-shi (JP)

(73) Assignee: SUZUKI MOTOR CORPORATION, Hamamatsu-shi (JP)

(21) Appl. No.: 19/240,551

(22) Filed: Jun. 17, 2025

(30) Foreign Application Priority Data
Jun. 19, 2024 (JP) 2024-098565

(51) Int. Cl. B62J 17/04

(52) U.S. Cl. CPC B62J 17/04

(57) ABSTRACT

A windscreen device includes left and right mounting mechanisms. Each of the mounting mechanisms includes a mounting member including a mounting plate, a male fixing member, a female fixing member coupled to the male fixing member, and a holding member to hold the female fixing member on a rear surface side of the mounting plate. The mounting plate is provided with a first and second mounting holes having different height positions. The male fixing member is inserted into one of the insertion holes, then inserted into one of the first and second mounting holes, and then coupled to the female fixing member, so that the windscreen is fixed to the mounting member. The female fixing member is held on the mounting member by the holding member to be movable between a position facing the first mounting hole and a position facing the second mounting hole.

### CROSS-REFERENCE TO RELATED APPLICATIONS

This application is based on and claims priority under 35 USC 119 from Japanese Patent Application No. 2024-098565, filed on Jun. 19, 2024, the contents of which are incorporated herein by reference.

### TECHNICAL FIELD

The present invention relates to a windscreen device and a straddle-type vehicle including the windscreen device.

### BACKGROUND ART

For the purpose of reducing wind that hits a driver during travelling, a windscreen may be provided in a straddle-type vehicle. In addition, the straddle-type vehicle provided with the windscreen has a height-variable structure capable of changing a height position of the windscreen. With the height-variable structure, a height of the windscreen can be adjusted according to a height of the driver, for example, and the windscreen can be made higher at the time of driving on a highway and the windscreen can be made lower at the time of driving on a general road.

JP2004-98859A (Patent Literature 1) describes a windscreen mounting structure for a motorcycle. This literature describes an example of a structure capable of changing a height position of a windscreen.

The height-variable structure of the windscreen is roughly classified into a remount type height-variable structure and a moving operation type height-variable structure.

The remount type height-variable structure is a height-variable structure that changes a height position of a windscreen by temporarily removing the windscreen from a vehicle body, changing a mounting position of the windscreen to the vehicle body, and then mounting the windscreen to the vehicle body again. In the remount type height-variable structure, the windscreen is fixed, by using a bolt and a nut, to a mounting hole provided in a windscreen mounting portion which is provided on a vehicle body side of a straddle-type vehicle. The windscreen mounting portion is a mounting member for mounting the windscreen fixed to, for example, a front cowl, a meter visor, or a front upper portion of the straddle-type vehicle. For example, when the windscreen is fixed to the windscreen mounting portion at four points, the windscreen is provided with four insertion holes, that is, first to fourth insertion holes. In the case of a structure in which the height position of the windscreen can be changed in, for example, three stages, three sets of four mounting holes corresponding to the four insertion holes of the windscreen, that is, three sets of the first to fourth mounting holes corresponding to the first to fourth insertion holes are provided in the windscreen mounting portion. The three first mounting holes are disposed at different height positions so that the first mounting hole belonging to a second set is disposed at a lower position than the first mounting hole belonging to a first set, and the first mounting hole belonging to a third set is disposed at a lower position than the first mounting hole belonging to the second set. Similarly, the three second mounting holes are also disposed at different height positions, similarly, the three third mounting holes are also disposed at different height positions, and similarly, the three fourth mounting holes are also disposed at different height positions. For example, the windscreen can be fixed to the windscreen mounting portion by inserting four bolts into the four insertion holes of the windscreen and the four mounting holes belonging to the first set of the windscreen mounting portion, and then fastening four nuts to four bolts. In this case, the height position of the windscreen is the highest position. In order to lower the windscreen, for example, by one step from this state, first coupling between the four bolts and the four nuts is released to temporarily remove the windscreen from the windscreen mounting portion, then the four bolts are inserted into the four insertion holes of the windscreen and are inserted into the four mounting holes belonging to the second set of the windscreen mounting portion, and then the four nuts are fastened to the four bolts to re-fix the windscreen to the windscreen mounting portion.

As the remount type height-variable structure, there are a structure in which the nuts are separated from the windscreen mounting portion and a structure in which the nuts are fixed to the windscreen mounting portion in advance.

In the remount type height-variable structure in which the nuts are separated from the windscreen mounting portion, the nuts are completely separated from the windscreen mounting portion in a state where the windscreen is removed from the windscreen mounting portion.

In the remount type height-variable structure in which the nuts are fixed to the windscreen mounting portion in advance, the nuts are fixed to all the mounting holes provided in the windscreen mounting portion in advance by means such as welding. In the case of this aspect, 12 mounting holes are provided in the windscreen mounting portion in the above-described example, and 12 nuts are fixed in advance at positions corresponding to the 12 mounting holes, respectively.

On the other hand, the moving operation type height-variable structure is a height-variable structure that changes a height position of a windscreen by performing a predetermined operation and moving the windscreen in an upper-lower direction while the windscreen is mounted to a vehicle body. Examples of the moving operation type height-variable structure include a structure that includes a mechanism for slidably supporting a windscreen on a vehicle body and a lock mechanism for locking the windscreen, in which the lock mechanism is operated to release lock of the windscreen, the windscreen is slid upward or downward with respect to the vehicle body, and then the lock mechanism is operated to lock the windscreen, and a structure that includes a motor for moving a windscreen in an upper-lower direction and an operation switch for operating the motor, in which the operation switch is operated to move the windscreen upward or downward with respect to the motor.

### CITATION LIST

### Patent Literature

Patent Literature 1: JP2004-98859A

### SUMMARY OF INVENTION

According to one advantageous aspect of invention, there is provided a windscreen device including:
a windscreen provided with a pair of left and right insertion holes; and
a pair of left and right mounting mechanisms configured to mount the windscreen to a vehicle body, wherein
each of the mounting mechanisms includes
a mounting member provided on the vehicle body and including a mounting plate which extends upward while being inclined rearward and extends in a left-right direction,
a male fixing member,
a female fixing member coupled to the male fixing member, and
a holding member configured to hold the female fixing member on a rear surface side of the mounting plate,
the mounting plate is provided with a first mounting hole and a second mounting hole having different height positions,
the male fixing member is inserted into one insertion hole of the pair of insertion holes, then inserted into one mounting hole of the first mounting hole and the second mounting hole, and then coupled to the female fixing member, so that the windscreen is fixed to the mounting member, and
the female fixing member is held on the mounting member by the holding member to be movable between a position facing the first mounting hole and a position facing the second mounting hole.

According to another advantageous aspect of invention, there is provided a straddle-type vehicle including the windscreen device as the above.

According to the present invention, the workability of the work of changing the height position of the windscreen can be improved, deterioration of the appearance of the straddle-type vehicle due to rust of the fixing member such as a nut can be prevented, and the number of components can be reduced.

### BRIEF DESCRIPTION OF DRAWINGS

FIG. 1 is a perspective view illustrating a front upper portion of a straddle-type vehicle according to an embodiment of the present invention.

FIG. 2A is a perspective view illustrating a windscreen device according to the embodiment of the present invention, and FIG. 2B is a view illustrating three height positions of a windscreen in the windscreen device.

FIG. 3 is a cross-sectional view of the windscreen device taken along a cutting line d-d in FIG. 2A.

FIG. 4A is a view illustrating a state before the windscreen is mounted to each mounting mechanism in the windscreen device according to the embodiment of the present invention, FIG. 4B is a view illustrating a mounting member and the like in the windscreen device, and FIG. 4C is a view illustrating a state where a holding member and the like is separated from the mounting member.

FIG. 5A is a front view of the mounting member of the windscreen device according to the embodiment of the present invention, FIG. 5B is a side view of the mounting member, and FIG. 5C is a cross-sectional view of the mounting member taken along a cutting line e-e in FIG. 5A.

FIG. 6A is a front view of the holding member of the windscreen device according to the embodiment of the present invention, FIG. 6B is a side view of the holding member, FIG. 6C is a cross-sectional view of the holding member taken along a cutting line f-f in FIG. 6A, and FIG. 6D is a bottom view of the holding member.

FIG. 7A is a front view illustrating the mounting member and the holding member locked to the mounting member in the windscreen device according to the embodiment of the present invention, FIG. 7B is a side view of the mounting member and the holding member, FIG. 7C is a cross-sectional view illustrating the mounting member and the holding member cut along a cutting line g-g in FIG. 7A, and FIG. 7D is a cross-sectional view illustrating the mounting member and the holding member cut along a cutting line h-h in FIG. 7A.

FIG. 8A is a cross-sectional view illustrating the mounting member and the holding member cut along a cutting line j-j in FIG. 7B, FIG. 8B is a view illustrating a process of removing the holding member from the mounting member, FIG. 8C is a view illustrating the holding member removed from the mounting member, FIG. 8D is a cross-sectional view illustrating the mounting member and the holding member cut along a cutting line k-k in FIG. 8A, and FIG. 8E is a cross-sectional view illustrating the mounting member and the holding member cut along a cutting line m-m in FIG. 8C.

FIG. 9A is a view illustrating a state where the holding member is locked at a first locking position of the mounting member in the windscreen device according to the embodiment of the present invention, FIG. 9B is a view illustrating a state where the holding member is locked at a second locking position of the mounting member, and FIG. 9C is a view illustrating a state where the holding member is locked at a third locking position of the mounting member.

FIG. 10A is a perspective view illustrating a modification of the mounting member and the holding member of the windscreen device according to the embodiment of the present invention, FIG. 10B is a perspective view illustrating a state where the mounting member and the holding member are separated from each other, FIG. 10C is a bottom view of the mounting member and the holding member, and FIG. 10D is a perspective view illustrating another modification of the mounting member and the holding member of the windscreen device according to the embodiment of the present invention.

### DESCRIPTION OF EMBODIMENTS

A height-variable structure of a windscreen in the related art has the following problems.

First, in a remount type height-variable structure in which a nut is able to be separated from a windscreen mounting portion, when the nut is removed from a bolt or the nut is mounted to the bolt in order to change a height position of a windscreen, the nut may be dropped and the nut may be lost. Therefore, the workability of the work of changing the height position of the windscreen may be deteriorated. In particular, when a driver of a straddle-type vehicle changes the height position of the windscreen at his/her destination, the environment of the place where the work is performed is bad, and the possibility that the nut is lost is increased.

Next, in a remount type height-variable structure in which a nut is fixed to a windscreen mounting portion in advance, a threaded hole of a nut not used for fixing a windscreen, that is, a threaded hole of a nut into which a bolt for fixing the windscreen is not inserted may rust. For example, when a coating film is formed on a surface of the nut for rust prevention, the coating film of the threaded hole of the nut is also scraped off by friction between a screw of the bolt and the threaded hole of the nut at the time of fastening the bolt and the nut. Thereafter, when the nut is left unused, the threaded hole of the nut rusts in a shorter period than other portions of the nut. The nut is fixed to the windscreen mounting portion disposed at the front upper portion of the straddle-type vehicle, and is disposed at a conspicuous position. Therefore, the rust of the threaded hole of the nut deteriorates the appearance of the straddle-type vehicle.

Next, the moving operation type height-variable structure has a large number of components, is expensive, is large, and is heavy.

The present invention has been made in view of the above-described problems, for example, and an object of the present invention is to provide a windscreen device and a straddle-type vehicle that can improve workability of work of changing a height position of a windscreen, prevent deterioration of an appearance of the straddle-type vehicle due to rust of a fixing member such as a nut, and reduce the number of components.

A windscreen device according to an embodiment of the present invention includes a windscreen provided with a pair of left and right insertion holes, and a pair of left and right mounting mechanisms for mounting the windscreen to a vehicle body.

The pair of mounting mechanisms have the same configuration or have configurations bilaterally symmetrical to each other.

Each of the mounting mechanisms includes a mounting member provided on the vehicle body, a male fixing member, a female fixing member coupled to the male fixing member, and a holding member configured to hold the female fixing member on the mounting member.

The mounting member includes a mounting plate extending upward while being inclined rearward and extending in a left-right direction. The mounting plate is provided with a first mounting hole and a second mounting hole having different height positions. In the present embodiment, in the mounting plate, for example, the first mounting hole is provided at a position higher than the second mounting hole.

The male fixing member is inserted into one insertion hole of the pair of insertion holes (insertion hole on left side when mounting mechanism is disposed at left portion of vehicle body, and insertion hole on right side when mounting mechanism is disposed at right portion of vehicle body), then inserted into one mounting hole of the first mounting hole and the second mounting hole, and then coupled to the female fixing member, so that the windscreen is fixed to the mounting member. When the male fixing member is inserted into the one insertion hole and the first mounting hole and then coupled to the female fixing member, so that the windscreen is fixed to the mounting member, a height position of the windscreen is a first height position. When the male fixing member is inserted into the one insertion hole and the second mounting hole and then coupled to the female fixing member, so that the windscreen is fixed to the mounting member, the height position of the windscreen is a second height position. In the present embodiment, since the first mounting hole is provided in the mounting plate at a position higher than a position where the second mounting hole is provided, the first height position is a position higher than the second height position.

The holding member holds the female fixing member on a rear surface side of the mounting plate. The female fixing member is held on the mounting member by the holding member to be movable between a position facing the first mounting hole and a position facing the second mounting hole.

In the windscreen device having such a configuration, a method of changing the height position of the windscreen is as follows.

For example, it is assumed that the windscreen is fixed to the mounting member of each of the mounting mechanisms to be at the first height position. At this time, in each mounting mechanism, the male fixing member is coupled to the female fixing members in a state of being inserted into one insertion hole of the windscreen and the first mounting hole. When the height position of the windscreen is changed from the first height position to the second height position in this state, a user first releases coupling between the male fixing member and the female fixing member in each mounting mechanism, and removes the windscreen from each mounting mechanism. Even in a state where the windscreen is removed from each mounting mechanism, in each mounting mechanism, the female fixing member is held on the rear surface side of the mounting plate by the holding member. Immediately after the windscreen fixed at the first height position is removed from each mounting mechanism, the female fixing member is held by the holding member at the position facing the first mounting hole.

Next, the user moves the female fixing member to the position facing the second mounting hole in each mounting mechanism. In each mounting mechanism, the female fixing member is held on the mounting member by the holding member to be movable between the position facing the first mounting hole and the position facing the second mounting hole, and thus the user can move the female fixing member to the position facing the second mounting hole. After the user moves the female fixing member to the position facing the second mounting hole, the female fixing member is held by the holding member at the position facing the second mounting hole.

Next, the user inserts the male fixing member into one insertion hole of the windscreen and the second mounting hole in each mounting mechanism, and then couples the male fixing member to the female fixing member held at the position facing the second mounting hole. Accordingly, the windscreen is fixed to the mounting member of each mounting mechanism, and the height position of the windscreen is the second height position.

In the windscreen device according to the present embodiment, the female fixing member is held on the mounting plate of the mounting member by the holding member, and thus at the time of releasing coupling between the male fixing member and the female fixing member or at the time of coupling the male fixing member and the female fixing member to each other, the female fixing member can be prevented from falling onto a gap of the vehicle body, the ground, or the like. Therefore, it is possible to prevent the female fixing member from being lost due to the fall of the female fixing member, and it is possible to prevent the work of changing the height position of the windscreen from being delayed due to the loss of the female fixing member. Accordingly, the workability of the work of changing the height position of the windscreen can be improved. With the windscreen device according to the present embodiment, the driver of the straddle-type vehicle can smoothly perform the work of changing the height position of the windscreen, for example, even in a place where the environment is bad at his/her destination.

In the windscreen device according to the present embodiment, the female fixing member is held on the mounting member by the holding member to be movable between the position facing the first mounting hole and the position facing the second mounting hole, when the windscreen is fixed to the first height position, the female fixing member is moved to the position facing the first mounting hole and then coupled to the male fixing member, and when the windscreen is fixed to the second height position, the female fixing member is moved to the position facing the second mounting hole and then coupled to the male fixing member. In this way, in the windscreen device according to the present embodiment, the same female fixing member is always used regardless of whether the windscreen is fixed at the first height position or at the second height position. Therefore, the appearance of the straddle-type vehicle is not deteriorated due to rust of the threaded hole of the nut which is not used for fixing the windscreen, as in the above-described remount type height-variable structure in which a nut is fixed to the windscreen mounting portion in advance.

The windscreen device according to the embodiment of the present invention has a smaller number of components than the above-described moving operation type height-variable structure having a mechanism that slidably supports a windscreen on a vehicle body and a lock mechanism that locks the windscreen, and the above-described moving operation type height-variable structure having a motor for moving a windscreen in an upper-lower direction and an operation switch for operating the motor. Therefore, with the windscreen device according to the embodiment of the present invention, the number of components of the windscreen device can be reduced, the windscreen device can be manufactured at low cost, and the windscreen device can be easily reduced in size and weight.

A straddle-type vehicle according to an embodiment of the present invention includes the above-described windscreen device according to the embodiment of the present invention. With the straddle-type vehicle according to the embodiment of the present invention, the workability of the work of changing the height position of the windscreen can be improved. In the straddle-type vehicle according to the embodiment of the present invention, the appearance of the straddle-type vehicle is not deteriorated due to the rust of the threaded hole of the nut which is not used for fixing the windscreen, as in the straddle-type vehicle including the remount type height-variable structure in which the nut is fixed to the windscreen mounting portion in advance. In addition, with the straddle-type vehicle according to the embodiment of the present invention, the number of components used in the windscreen device among the components of the straddle-type vehicle can be reduced as compared with a straddle-type vehicle including a moving operation type height-variable structure. Therefore, the straddle-type vehicle can be manufactured at low cost, and the straddle-type vehicle can be easily reduced in size and weight.

### EMBODIMENT

An embodiment of a windscreen device according to the present invention and an embodiment of a straddle-type vehicle according to the present invention will be described with reference to the drawings.

### (Straddle-Type Vehicle)

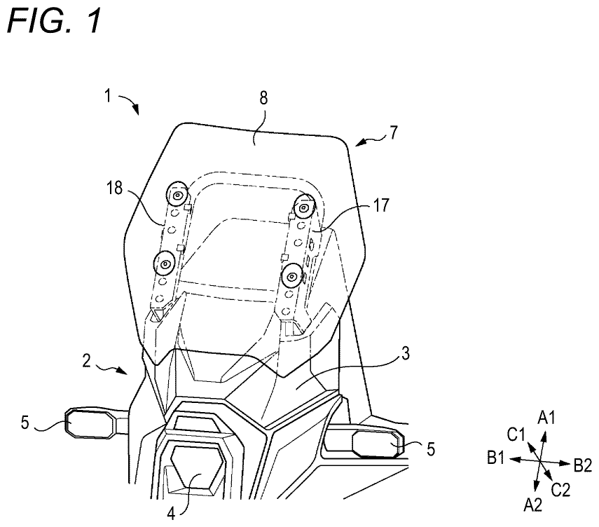

FIG. 1 illustrates a front upper portion of a straddle-type vehicle 1 according to the embodiment of the present invention. The straddle-type vehicle 1 is, for example, a motorcycle. As illustrated in FIG. 1, a front cover 3, a headlight 4, a winker 5, and the like are provided on a front upper portion of a vehicle body 2 of the straddle-type vehicle 1. The straddle-type vehicle 1 includes a windscreen device 7 according to the embodiment of the present invention. The windscreen device 7 is provided above the front cover 3 at the front upper portion of the vehicle body 2 of the straddle-type vehicle 1.

### (Windscreen Device)

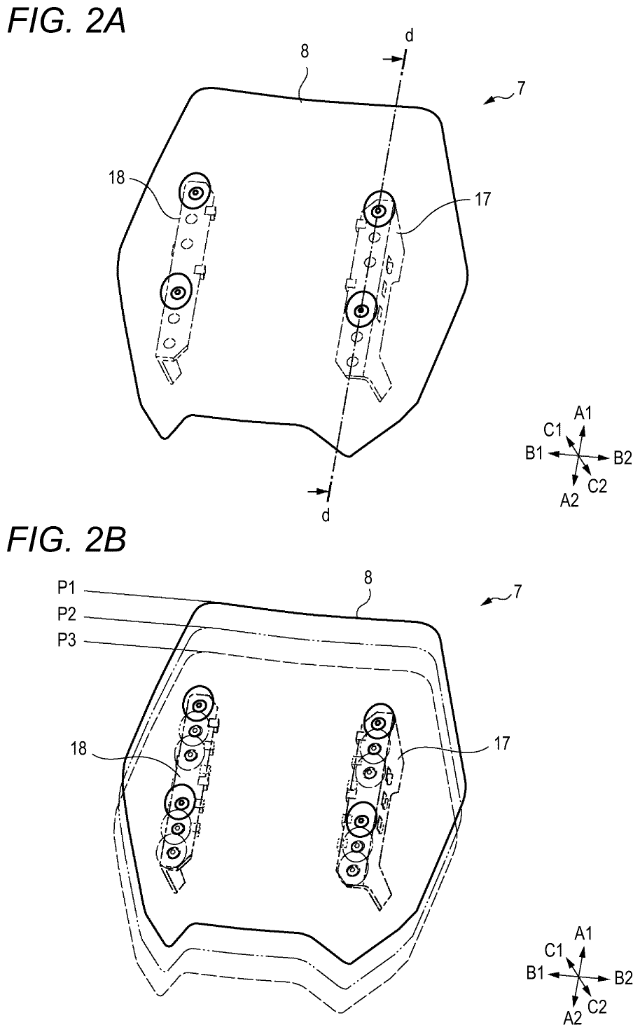

FIG. 2A illustrates the windscreen device 7. As illustrated in FIG. 2A, the windscreen device 7 includes a windscreen 8 and a pair of mounting mechanisms 17 and 18 for mounting the windscreen 8 to the vehicle body 2.

The windscreen device 7 has a height-variable structure capable of changing a height position of the windscreen 8 in, for example, three stages. FIG. 2B illustrates three height positions of the windscreen 8 which may be changed in the windscreen device 7. As illustrated in FIG. 2B, in the windscreen device 7, the height position of the windscreen 8 can be changed among a first height position P1, a second height position P2, and a third height position P3.

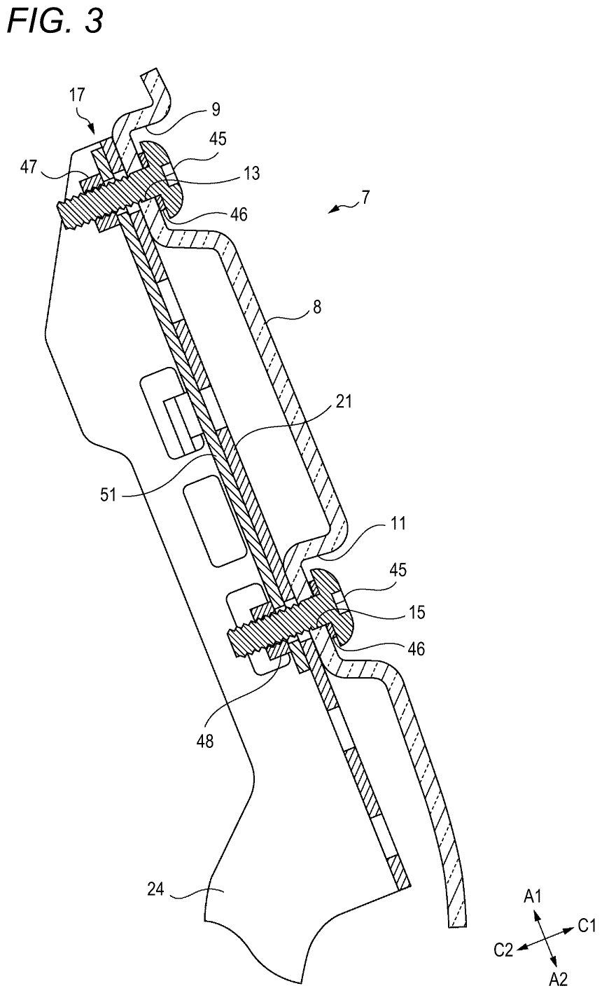

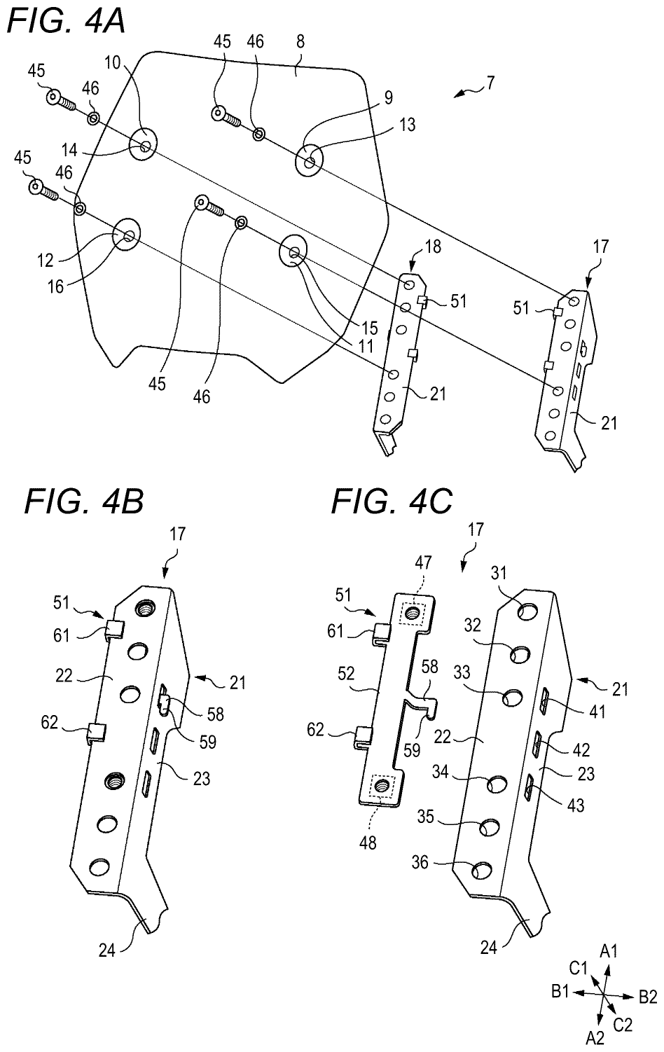

FIG. 3 illustrates a cross section of the windscreen device 7 cut along a cutting line d-d in FIG. 2A as viewed from the left in FIG. 2A. FIG. 4A illustrates a state before the windscreen 8 is mounted to the mounting mechanisms 17 and 18. FIG. 4B illustrates a mounting member 21, a holding member 51, and the like of the mounting mechanism 17 provided on one side in a left-right direction of the front upper portion of the vehicle body 2, of the pair of mounting mechanisms 17 and 18 of the windscreen device 7. FIG. 4C illustrates a state where the holding member 51 and the like are separated from the mounting member 21 in FIG. 4B.

### (Windscreen)

The windscreen 8 is formed of, for example, a transparent resin material in a plate shape. As illustrated in FIG. 4A, recesses 9, 10, 11, and 12 are formed in an upper portion on one side in the left-right direction, an upper portion on the other side in the left-right direction, a lower portion on one side in the left-right direction, and a lower portion on the other side in the left-right direction of the windscreen 8, respectively. Insertion holes 13, 14, 15, and 16 are formed in the upper portion of one side in the left-right direction, the upper portion of the other side in the left-right direction, the lower portion of one side in the left-right direction, and the lower portion of the other side in the left-right direction of the windscreen 8, respectively. Specifically, a pair of left and right insertion holes 13 and 14 are formed in the upper portion of the windscreen 8, and a pair of left and right insertion holes 15 and 16 are formed in the lower portion of the windscreen 8. The four insertion holes 13 to 16 are disposed at center portions of bottom portions of the four recesses 9 to 12, respectively. As illustrated in FIG. 1, when the windscreen 8 is mounted to the vehicle body 2 via the mounting mechanisms 17 and 18, the windscreen 8 is disposed at the front upper portion of the vehicle body 2 of the straddle-type vehicle 1 such that a surface (front surface) of the windscreen 8 extends upward while being inclined rearward and extends in the left-right direction in the straddle-type vehicle 1.

### (Mounting Mechanism)

As illustrated in FIG. 1, of the pair of mounting mechanisms 17 and 18 of the windscreen device 7, one mounting mechanism 17 is provided on one side in the left-right direction of the front upper portion of the vehicle body 2, and the other mounting mechanism 18 is provided on the other side in the left-right direction of the front upper portion of the vehicle body 2. The pair of mounting mechanisms 17 and 18 have configurations that are bilaterally symmetrical to each other. As illustrated in FIGS. 4A to 4C, each of the mounting mechanisms 17 and 18 includes the mounting member 21, two male fixing members 45, two cushion members 46, two female fixing members 47 and 48, and the holding member 51.

In each of the mounting mechanisms 17 and 18, the mounting member 21 is fixed to the front upper portion of the vehicle body 2. As illustrated in FIG. 4C, three upper mounting holes 31, 32, and 33 having different height positions are formed in an upper portion of the mounting member 21. Three lower mounting holes 34, 35, and 36 having different height positions are formed in a lower portion of the mounting member 21. As illustrated in FIG. 4A, each of the male fixing members 45 is, for example, a bolt. Each of the cushion members 46 is, for example, a cushion washer. As illustrated in FIG. 4C, the two female fixing members 47 and 48 are fixed to a rear surface side of the holding member 51. Each of the female fixing members 47 and 48 is a nut, for example. The female fixing members 47 and 48 can be coupled to the male fixing member 45. The holding member 51 is a member that causes the mounting member 21 to hold the two female fixing members 47 and 48. As can be seen from FIGS. 4B and 4C, the holding member 51 is detachably locked to the mounting member 21. For example, when the windscreen 8 is mounted to the vehicle body 2 such that the height position of the windscreen 8 is the first height position P1 in FIG. 2B, as illustrated in FIG. 4A, one male fixing member 45 of one mounting mechanism 17 is inserted into the insertion hole 13 formed in the upper portion of the windscreen 8 on one side in the left-right direction via the cushion member 46, the male fixing member 45 is then inserted into the upper mounting hole 31 formed in the mounting member 21 of one mounting mechanism 17, and the male fixing member 45 is then coupled to one female fixing member 47 of one mounting mechanism 17 (see FIG. 3). In addition, one male fixing member 45 of the other mounting mechanism 18 is inserted into the insertion hole 14 formed in the upper portion of the windscreen 8 on the other side in the left-right direction via the cushion member 46, the male fixing member 45 is then inserted into the upper mounting hole 31 formed in the mounting member 21 of the other mounting mechanism 18, and the male fixing member 45 is then coupled to one female fixing member 47 of the other mounting mechanism 18. Further, the other male fixing member 45 of one mounting mechanism 17 is inserted into the insertion hole 15 formed in the lower portion of the windscreen 8 on one side in the left-right direction via the cushion member 46, the male fixing member 45 is then inserted into the lower mounting hole 34 formed in the mounting member 21 of one mounting mechanism 17, and the male fixing member 45 is then coupled to the other female fixing member 48 of one mounting mechanism 17 (see FIG. 3). In addition, the other male fixing member 45 of the other mounting mechanism 18 is inserted into the insertion hole 16 formed in the lower portion of the windscreen 8 on the other side in the left-right direction via the cushion member 46, the male fixing member 45 is then inserted into the lower mounting hole 34 formed in the mounting member 21 of the other mounting mechanism 18, and the male fixing member 45 is then coupled to the other female fixing member 48 of the other mounting mechanism 18. Further, four sets of the male fixing member 45 and the female fixing member 47 (or 48) which are coupled to each other are fastened, so that the windscreen 8 is fixed to the mounting member 21 of each of the mounting mechanisms 17 and 18.

### (Mounting Member)

A detailed configuration of the mounting member 21 of one mounting mechanism 17 will be described. The mounting member 21 of the other mounting mechanism 18 has a configuration bilaterally symmetrical to that of the mounting member 21 of one mounting mechanism 17, and thus the description of the detailed configuration of the mounting member 21 of the other mounting mechanism 18 will be omitted. In the description of the detailed configuration of the mounting member 21, arrows A1, A2, B1, B2, C1, and C2 drawn mainly in a lower right side of each drawing are followed at the time of describing directions. An arrow A1 direction is an upward direction inclined rearward as viewed from a driver of the straddle-type vehicle 1. An arrow B1 direction is a rightward direction as viewed from the driver. An arrow C1 direction is a direction orthogonal to the arrow A1 direction and the arrow B1 direction, and is a forward direction inclined upward as viewed from the driver. An arrow A2 direction, an arrow B2 direction, and an arrow C2 direction are opposite to the arrow A1 direction, the arrow B1 direction, and the arrow C1 direction, respectively.

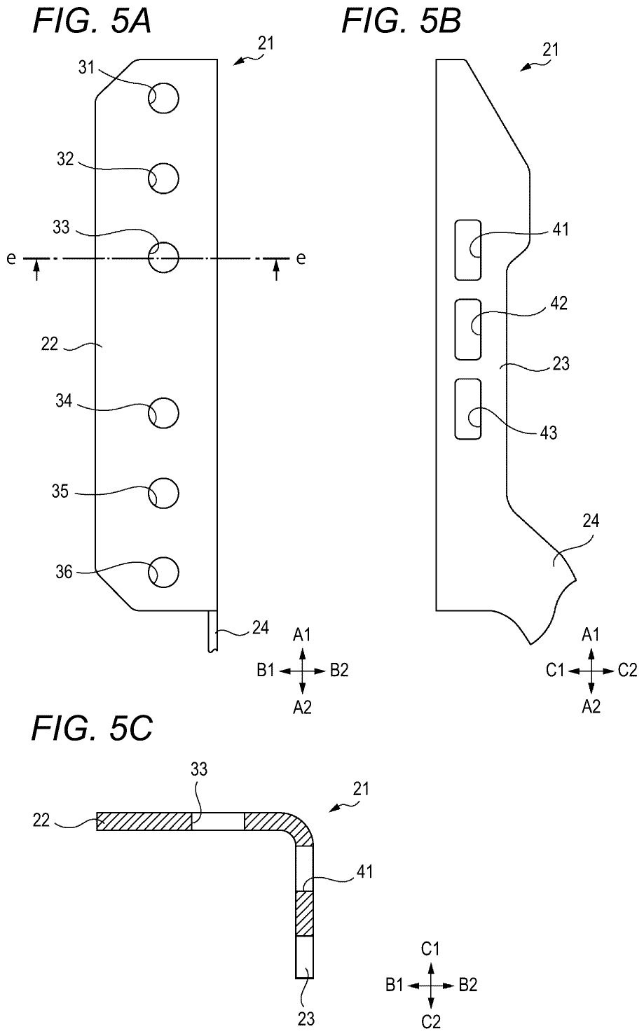

FIG. 5A is a front view of the mounting member 21. FIG. 5B is a side view of the mounting member 21. FIG. 5C illustrates a cross section of the mounting member 21 taken along a cutting line e-e in FIG. 5A as viewed from below in FIG. 5A.

The mounting member 21 is a member for mounting the windscreen 8 to the vehicle body 2. The mounting member 21 is formed of, for example, a metal material or a resin material having high strength. The mounting member 21 includes a mounting plate 22 and a locking plate 23. As illustrated in FIG. 5A, the mounting plate 22 is formed in a flat plate shape extending upward (arrow A1 direction) while being inclined rearward and extending in the left-right direction (arrow B1-B2 direction). As illustrated in FIGS. 5B and 5C, the locking plate 23 extends rearward (arrow C2 direction) while being inclined downward from an edge portion of the mounting plate 22 on one side (arrow B2 direction side) in the left-right direction. The mounting member 21 has an L-shaped cross section as illustrated in FIG. 5C.

As illustrated in FIG. 5B, an installation portion 24 for installing the mounting member 21 on the front upper portion of the vehicle body 2 is formed on a lower end side (arrow A2 direction side) of the locking plate 23. Although not illustrated, the installation portion 24 is provided at the front upper portion of the vehicle body 2, such as a cowling brace, and is fixed to a component having high strength and firmly supported by a vehicle body frame.

As illustrated in FIG. 5A, three upper mounting holes 31, 32, and 33 having different height positions are formed in an upper portion (portion on arrow A1 direction side) of the mounting plate 22. Three lower mounting holes 34, 35, and 36 having different height positions are formed in a lower portion (portion on arrow A2 direction side) of the mounting plate 22. A distance between the upper mounting hole 31 and the lower mounting hole 34, a distance between the upper mounting hole 32 and the lower mounting hole 35, and a distance between the upper mounting hole 33 and the lower mounting hole 36 are equal to one another. Each of the three distances is equal to a distance between the insertion hole 13 and the insertion hole 15 in the windscreen 8.

As illustrated in FIG. 5B, three locking holes 41, 42, and 43 having different height positions are formed in the locking plate 23. The locking holes 41 to 43 are holes for locking the holding member 51 at any locking position of a first locking position, a second locking position, and a third locking position to be described later. A shape of each of the locking holes 41 to 43 is a rectangular shape or an elliptical shape that is long in an arrow A1-A2 direction so that a stop 59 of the holding member 51 can be inserted into each of the locking holes 41 to 43.

### (Holding Member)

A detailed configuration of the holding member 51 of one mounting mechanism 17 will be described. The holding member 51 of the other mounting mechanism 18 has a configuration bilaterally symmetrical to that of the holding member 51 of one mounting mechanism 17, and thus the description of the detailed configuration of the holding member 51 of the other mounting mechanism 18 will be omitted. In the description of the detailed configuration of the holding member 51, the arrows A1, A2, B1, B2, C1, and C2 drawn mainly in the lower right side of each drawing are followed at the time of describing directions.

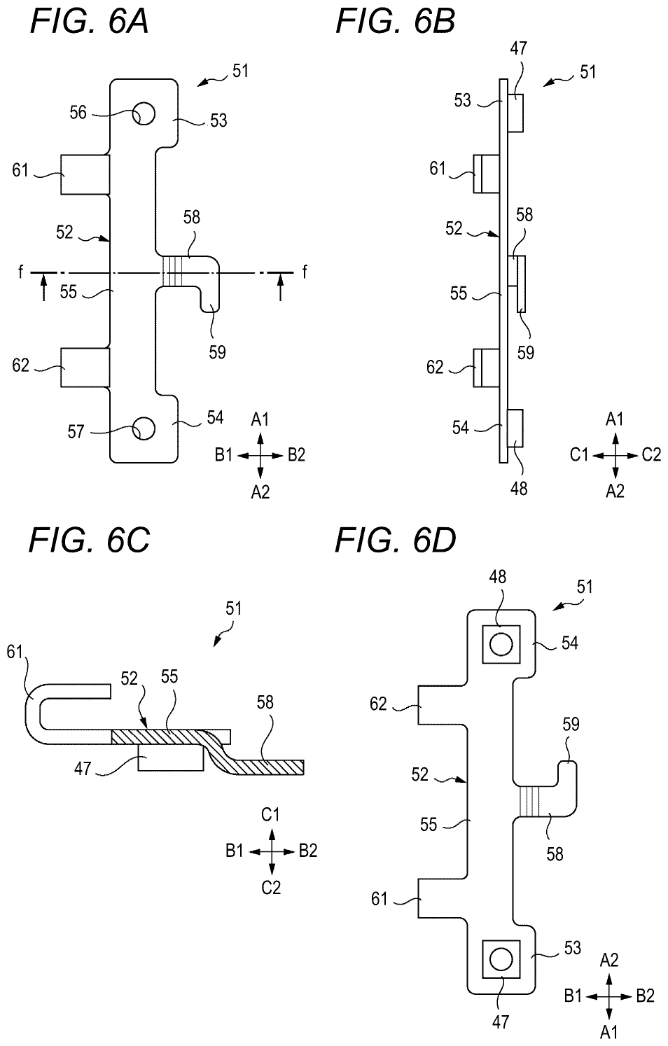

FIG. 6A is a front view of the holding member 51. FIG. 6B is a side view of the holding member 51. FIG. 6C illustrates a cross section of the holding member 51 cut along a cutting line f-f in FIG. 6A as viewed from below in FIG. 6A. FIG. 6D is a bottom view of the holding member 51.

The holding member 51 mainly has (i) a function of coupling the two female fixing members 47 and 48 to each other, (ii) a function of holding one female fixing member 47 on the rear surface side of the upper portion of the mounting plate 22 of the mounting member 21 and holding the other female fixing member 48 on the rear surface side of the lower portion of the mounting plate 22, (iii) a function of positioning the two female fixing members 47 and 48 at positions facing the upper mounting hole 31 and the lower mounting hole 34, positions facing the upper mounting hole 32 and the lower mounting hole 35, and positions facing the upper mounting hole 33 and the lower mounting hole 36, respectively, and (iv) a function of easily moving the two female fixing members 47 and 48 between the positions facing the upper mounting hole 31 and the lower mounting hole 34, the positions facing the upper mounting hole 32 and the lower mounting hole 35, and the positions facing the upper mounting hole 33 and the lower mounting hole 36, respectively.

The holding member 51 is formed of, for example, a metal material or a resin material having high strength. As illustrated in FIG. 6A, the holding member 51 includes a base portion 52, an insertion type locked portion 58, the stop 59, and two hanging type locked portions 61 and 62.

The base portion 52 is formed in a flat plate shape extending in the arrow A1 direction and extending in an arrow B1-B2 direction. In the base portion 52, an end portion on the arrow A1 direction side is a fixing portion 53, an end portion on the arrow A2 direction side is a fixing portion 54, and an intermediate portion in the arrow A1-A2 direction is a coupling portion 55. As illustrated in FIG. 6D, one female fixing member 47 is fixed to a surface (rear surface) of the fixing portion 53 on the arrow C2 direction side by, for example, welding or using an adhesive. Similarly, the other female fixing member 48 is fixed to a surface of the fixing portion 54 on the arrow C2 direction side. The two female fixing members 47 and 48 are fixed to the fixing portions 53 and 54, respectively, and as a result, the two female fixing members 47 and 48 are coupled to each other via the coupling portion 55. A distance between the two female fixing members 47 and 48 coupled to each other by the coupling portion 55 is equal to the distance between the upper mounting hole 31 and the lower mounting hole 34, the distance between the upper mounting hole 32 and the lower mounting hole 35, and the distance between the upper mounting hole 33 and the lower mounting hole 36 in the mounting member 21. As illustrated in FIG. 6A, an insertion hole 56 is formed in the fixing portion 53, and an insertion hole 57 is formed in the fixing portion 54. A position of the insertion hole 56 and a position of the female fixing member 47 fixed to the fixing portion 53 coincide with each other, and a position of the insertion hole 57 and a position of the female fixing member 48 fixed to the fixing portion 54 coincide with each other. The male fixing member 45 is inserted into the insertion hole 56 from the arrow C1 direction side and is coupled to the female fixing member 47 fixed to the fixing portion 53, or is inserted into the insertion hole 57 from the arrow C1 direction side and is coupled to the female fixing member 48 fixed to the fixing portion 54.

The insertion type locked portion 58 is provided at the intermediate portion of the base portion 52 in the arrow A1-A2 direction. The insertion type locked portion 58 extends in the arrow B2 direction from the base portion 52. Specifically, as illustrated in FIG. 6C, the insertion type locked portion 58 extends in the arrow C2 direction from an edge portion of the base portion 52 on the arrow B2 direction side, then bends in the arrow B2 direction, and then extends in the arrow B2 direction.

The stop 59 is provided at a distal end of the insertion type locked portion 58. As illustrated in FIG. 6A, the stop 59 extends in the arrow A2 direction from the distal end of the insertion type locked portion 58.

The hanging type locked portion 61 is provided at a portion of the base portion 52 on the arrow A1 side, and the hanging type locked portion 62 is provided at a portion of the base portion 52 on the arrow A2 side. As illustrated in FIG. 6C, each of the hanging type locked portions 61 and 62 extends in the arrow B1 direction from an edge portion of the base portion 52 on an arrow B1 direction side, bends in the arrow C1 direction, then extends in the arrow C1 direction, further bends in the arrow B2 direction, and then extends in the arrow B2 direction.

### (Locking of Holding Member by Mounting Member)

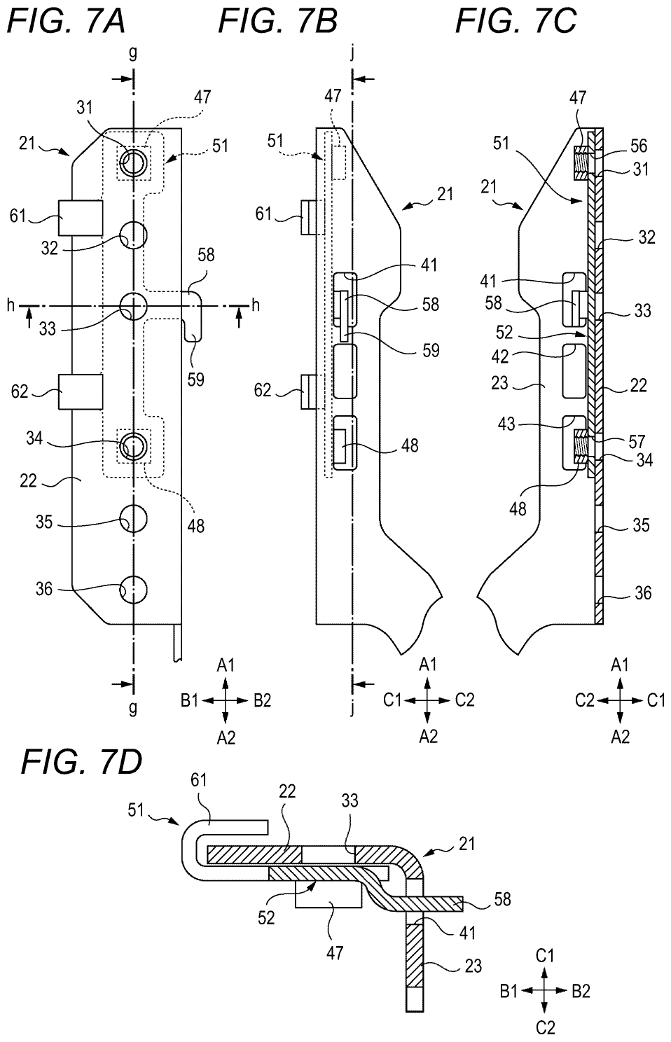

FIG. 7A is a front view of the mounting member 21 to which the holding member 51 is locked. FIG. 7B is a side view of the mounting member 21 to which the holding member 51 is locked. FIG. 7C illustrates a state where a cross section of each of the mounting member 21 and the holding member 51 cut along a cutting line g-g in FIG. 7A is viewed from the left in FIG. 7A. FIG. 7D illustrates a cross section of each of the mounting member 21 and the holding member 51 cut along a cutting line h-h in FIG. 7A as viewed from below in FIG. 7A.

As illustrated in FIGS. 7A to 7D, the base portion 52 of the holding member 51 is disposed on the rear surface side (arrow C2 direction side) of the mounting member 21. The holding member 51 is detachably locked with the mounting member 21. Specifically, the insertion type locked portion 58 is inserted into any locking hole of the locking holes 41 to 43 to be detachably locked to the locking hole. Each of the hanging type locked portions 61 and 62 sandwiches the edge portion of the mounting plate 22 on the other side in the left-right direction (arrow B1 direction side), thereby being detachably locked to the edge portion of the mounting plate 22 on the other side in the left-right direction. The holding member 51 is detachably locked to the mounting member 21 by the insertion type locked portion 58 and the hanging type locked portions 61 and 62 being locked to the mounting member 21 in this way. Since the locking holes 41 to 43 are formed in the locking plate 23 extending from the edge portion of the mounting plate 22 of the mounting member 21 on one side in the left-right direction, a structure in which the insertion type locked portion 58 is locked into any locking hole of the locking holes 41 to 43 can be considered to be an aspect of a structure in which the insertion type locked portion 58 is locked into the edge portion of the mounting plate 22 on one side in the left-right direction. Thus, substantially, it can be said that the insertion type locked portion 58 is locked to any locking hole of the locking holes 41 to 43 and the hanging type locked portions 61 and 62 are locked to the edge portion of the mounting plate 22 on the other side in the left-right direction, so that the holding member 51 is locked to the edge portion of the mounting plate 22 of the mounting member 21 on one side in the left-right direction and the edge portion of the mounting plate 22 on the other side in the left-right direction.

The holding member 51 is detachably fixed (temporarily fixed) to the mounting member 21 by the stop 59. That is, the stop 59 can also pass through any of the locking holes 41 to 43, but after the stop 59 passes through any locking hole of the locking holes 41 to 43 from the arrow B1 direction side to the arrow B2 direction side, the holding member 51 is lowered in the arrow A2 direction with respect to the mounting member 21 by its own weight, so that the stop 59 is caught by the one locking hole (see FIG. 7B). As a result, the stop 59 is unlikely to come off from the one locking hole in the arrow B1 direction. After the holding member 51 is locked to the mounting member 21, the holding member 51 is also temporarily fixed to the mounting member 21 by the stop 59 being caught in one locking hole in a state where the male fixing member 45 is not coupled to the female fixing members 47 and 48.

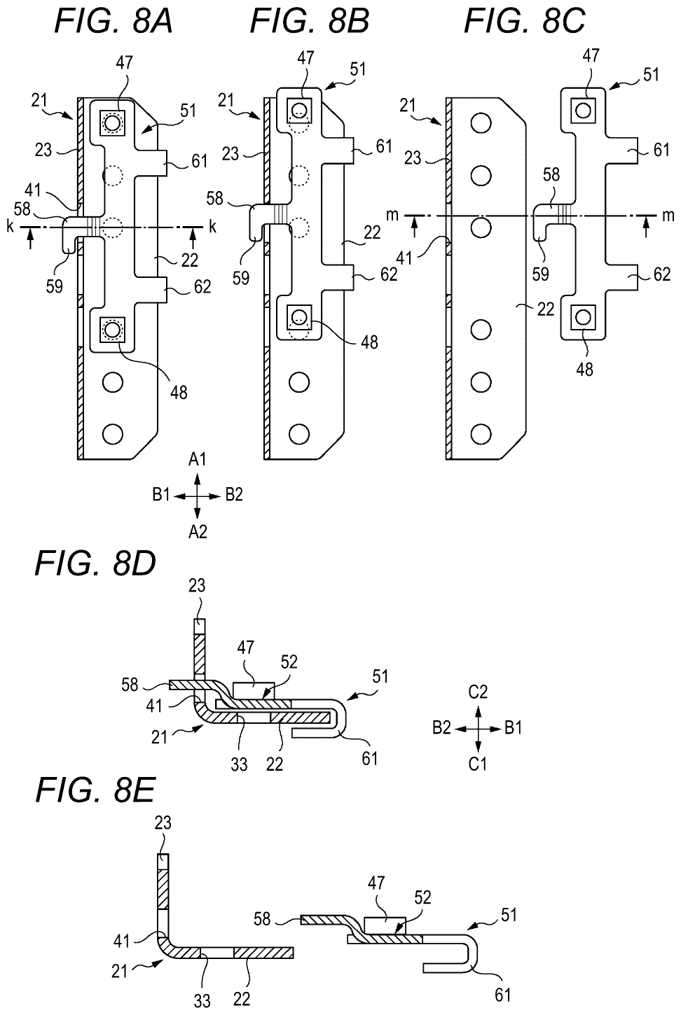

FIG. 8A illustrates a cross section of the mounting member 21 taken along a cutting line j-j in FIG. 7B, and the holding member 51 locked to the mounting member 21. FIGS. 8B and 8C illustrate a method of removing the holding member 51 locked to the mounting member 21 from the mounting member 21 as illustrated in FIG. 8A. FIG. 8D illustrates a cross section of the mounting member 21 and the holding member 51 taken along a cutting line k-k in FIG. 8A. FIG. 8E illustrates a cross section of the mounting member 21 and the holding member 51 cut along a cutting line m-m in FIG. 8C.

When the male fixing member 45 is not coupled to the female fixing members 47 and 48, the holding member 51 can be easily removed and separated from the mounting member 21 as illustrated in FIGS. 8A to 8E. That is, the insertion type locked portion 58 is inserted into any locking hole of the locking holes 41 to 43 from the arrow B1 direction side to the arrow B2 direction side of the locking hole to be locked in the locking hole. Further, each of the hanging type locked portions 61 and 62 sandwiches the edge portion of the mounting plate 22 on the arrow B1 direction side from the arrow B1 direction side to be locked to the edge portion of the mounting plate 22 on the arrow B1 direction side. Therefore, the holding member 51 is lifted from the state illustrated in FIG. 8A in the arrow A1 direction as illustrated in FIG. 8B to release temporary stopping of the stop 59, so that the stop 59 can easily come off from the locking hole, and then the holding member 51 is moved in the arrow B1 direction as illustrated in FIGS. 8C and 8E, so that the holding member 51 can be easily removed and separated from the mounting member 21.

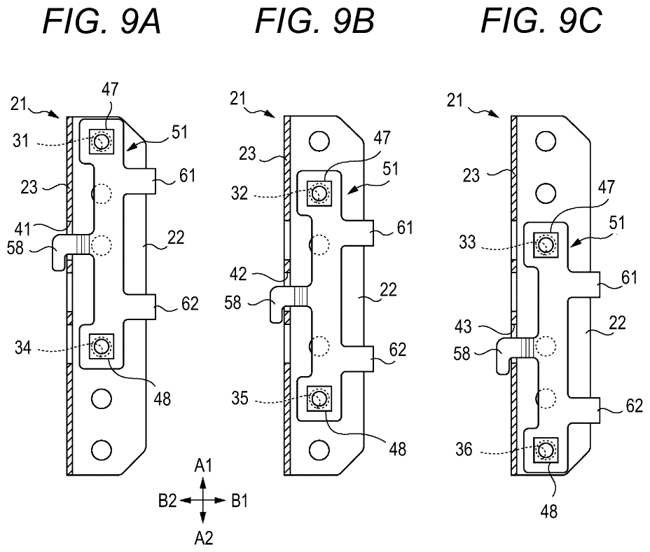

FIG. 9A illustrates a state where the holding member 51 is locked at the first locking position of the mounting member 21. FIG. 9B illustrates a state where the holding member 51 is locked at the second locking position of the mounting member 21. FIG. 9C illustrates a state where the holding member 51 is locked at the third locking position of the mounting member 21.

The mounting mechanism 17 is configured such that the holding member 51 is located and locked at any locking position of the first locking position, the second locking position, and the third locking position of the mounting member 21. As illustrated in FIG. 9A, the first locking position is a position where one female fixing member 47 faces the upper mounting hole 31 and the other female fixing member 48 faces the lower mounting hole 34. When the holding member 51 is locked at the first locking position of the mounting member 21, one female fixing member 47 is disposed at the position facing the upper mounting hole 31, and the other female fixing member 48 is disposed at the position facing the lower mounting hole 34. When the insertion type locked portion 58 enters the locking hole 41 and the holding member 51 is locked to the mounting member 21 by the hanging type locked portions 61 and 62 sandwiching the edge portion of the mounting plate 22 on the arrow B1 direction side, the position of the holding member 51 is the first locking position. As illustrated in FIG. 9B, the second locking position is a position where one female fixing member 47 faces the upper mounting hole 32 and the other female fixing member 48 faces the lower mounting hole 35. When the holding member 51 is locked at the second locking position of the mounting member 21, one female fixing member 47 is disposed at the position facing the upper mounting hole 32, and the other female fixing member 48 is disposed at the position facing the lower mounting hole 35. When the insertion type locked portion 58 enters the locking hole 42 and the holding member 51 is locked to the mounting member 21 by the hanging type locked portions 61 and 62 sandwiching the edge portion of the mounting plate 22 on the arrow B1 direction side, the position of the holding member 51 is the second locking position. As illustrated in FIG. 9C, the third locking position is a position where one female fixing member 47 faces the upper mounting hole 33 and the other female fixing member 48 faces the lower mounting hole 36. When the holding member 51 is locked at the third locking position of the mounting member 21, one female fixing member 47 is disposed at the position facing the upper mounting hole 33, and the other female fixing member 48 is disposed at the position facing the lower mounting hole 36. When the insertion type locked portion 58 enters the locking hole 43 and the holding member 51 is locked to the mounting member 21 by the hanging type locked portions 61 and 62 sandwiching the edge portion of the mounting plate 22 on the arrow B1 direction side, the position of the holding member 51 is the third locking position.

When the holding member 51 is locked at the first locking position of the mounting member 21, one female fixing member 47 is held at the position facing the upper mounting hole 31, and the other female fixing member 48 is held at the position facing the lower mounting hole 34. When the holding member 51 is removed from the mounting member 21 and locked at the second locking position of the mounting member 21 from the state of being locked at the first locking position of the mounting member 21, one female fixing member 47 moves from the position facing the upper mounting hole 31 to the position facing the upper mounting hole 32 and is held at that position, and the other female fixing member 48 moves from the position facing the lower mounting hole 34 to the position facing the lower mounting hole 35 and is held at that position. When the holding member 51 is removed from the mounting member 21 and locked at the third locking position of the mounting member 21 from the state of being locked at the second locking position of the mounting member 21, one female fixing member 47 moves from the position facing the upper mounting hole 32 to the position facing the upper mounting hole 33 and is held at that position, and the other female fixing member 48 moves from the position facing the lower mounting hole 35 to the position facing the lower mounting hole 36 and is held at that position.

### (Change in Height Position of Windscreen)

A method of changing the height position of the windscreen 8 in the windscreen device 7 will be described. For example, as illustrated in FIG. 2A, it is assumed that the windscreen 8 is mounted to the mounting mechanisms 17 and 18 to be located at the first height position P1. In this state, when the height position of the windscreen 8 is changed from the first height position P1 to the second height position P2, a user first releases mutual coupling of the total four sets of the male fixing member 45 and the female fixing member 47 (or 48) in the pair of mounting mechanisms 17 and 18, and then removes the windscreen 8 from the mounting mechanisms 17 and 18. In a state where the windscreen 8 is removed from the mounting mechanisms 17 and 18, in the mounting mechanisms 17 and 18, the female fixing members 47 and 48 are also held by the holding member 51 on the rear surface side of the mounting plate 22 of the mounting member 21. Immediately after the windscreen 8 fixed at the first height position P1 is removed from the mounting mechanisms 17 and 18, in each of the mounting mechanisms 17 and 18, one female fixing member 47 is held at the position facing the upper mounting hole 31 by the holding member 51 locked at the first locking position of the mounting member 21, and the other female fixing member 48 is held at the position facing the lower mounting hole 34 by the holding member 51.

Next, in each of the mounting mechanisms 17 and 18, the user removes the holding member 51 locked at the first locking position of the mounting member 21 from the mounting member 21, and locks the removed holding member 51 at the second locking position of the mounting member 21. Accordingly, one female fixing member 47 moves from the position facing the upper mounting hole 31 to the position facing the upper mounting hole 32, and at the same time, the other female fixing member 48 moves from the position facing the lower mounting hole 34 to the position facing the lower mounting hole 35. One female fixing member 47 is held at the position facing the upper mounting hole 32 by the holding member 51 locked at the second locking position of the mounting member 21, and the other female fixing member 48 is held at the position facing the lower mounting hole 35 by the holding member 51.

Next, the user inserts, via the cushion member 46, one male fixing member 45 of one mounting mechanism 17 into the insertion hole 13 of the windscreen 8 and the upper mounting hole 32 formed in the mounting member 21 of the mounting mechanism 17, and then couples the male fixing member 45 to the one female fixing member 47 of the one mounting mechanism 17. In addition, the user inserts, via the cushion member 46, one male fixing member 45 of the other mounting mechanism 18 into the insertion hole 14 of the windscreen 8 and the upper mounting hole 32 formed in the mounting member 21 of the other mounting mechanism 18, and then couples the male fixing member 45 to one female fixing member 47 of the other mounting mechanism 18. In addition, the user inserts, via the cushion member 46, the other male fixing member 45 of one mounting mechanism 17 into the insertion hole 15 of the windscreen 8 and the lower mounting hole 35 formed in the mounting member 21 of one mounting mechanism 17, and then couples the male fixing member to the other female fixing member 48 of one mounting mechanism 17. In addition, the user inserts, via the cushion member 46, the other male fixing member 45 of the other mounting mechanism 18 into the insertion hole 16 of the windscreen 8 and the lower mounting hole 35 formed in the mounting member 21 of the other mounting mechanism 18, and then couples the male fixing member 45 to the other female fixing member 48 of the other mounting mechanism 18. Then, the four sets of the male fixing member 45 and the female fixing member 47 (or 48) coupled to one another are fastened to one another. Accordingly, the windscreen 8 is fixed to the mounting member 21 of each of the mounting mechanisms 17 and 18, and the height position of the windscreen 8 is the second height position P2.

As described above, the windscreen device 7 according to the embodiment of the present invention includes the holding member 51 that holds the female fixing members 47 and 48 on the rear surface side of the mounting plate 22 of the mounting member 21. The female fixing members 47 and 48 are held on the rear surface side of the mounting plate 22 by the holding member 51, so that at the time of releasing coupling between the male fixing member 45 and the female fixing member 47 (or 48) or at the time of coupling the male fixing member 45 and the female fixing member 47 (or 48), the female fixing member 47 (or 48) can be prevented from falling onto a gap of the vehicle body 2, the ground, or the like. Therefore, it is possible to prevent the female fixing member 47 (or 48) from being lost due to the fall of the female fixing member 47 (or 48), and it is possible to prevent the work of changing the height position of the windscreen 8 from being delayed due to the loss of the female fixing member 47 (or 48). Accordingly, the workability of the work of changing the height position of the windscreen 8 can be improved.

In the windscreen device 7 according to the present embodiment, one female fixing member 47 is held on the mounting member 21 by the holding member 51 to be movable between the position facing the upper mounting hole 31, the position facing the upper mounting hole 32, and the position facing the upper mounting hole 33, and the other female fixing member 48 is held on the mounting member 21 by the holding member 51 to be movable between the position facing lower mounting hole 34, the position facing lower mounting hole 35, and the position facing lower mounting hole 36. When the windscreen 8 is fixed at the first height position P1, the two female fixing members 47 and 48 are moved to the position facing the upper mounting hole 31 and the position facing the lower mounting hole 34, respectively, and the two male fixing members 45 are coupled to the two female fixing members 47 and 48. When the windscreen 8 is fixed at the second height position P2, the two female fixing members 47 and 48 are moved to the position facing the upper mounting hole 32 and the position facing the lower mounting hole 35, respectively, and the two male fixing members 45 are coupled to the two female fixing members 47 and 48. When the windscreen 8 is fixed at the third height position P3, the two female fixing members 47 and 48 are moved to the position facing the upper mounting hole 33 and the position facing the lower mounting hole 36, respectively, and the two male fixing members 45 are coupled to the two female fixing members 47 and 48. In this way, in the windscreen device 7 according to the present embodiment, the same two female fixing members 47 and 48 are always used regardless of whether the windscreen 8 is fixed at the first height position P1, at the second height position P2, or at the third height position P3. That is, in the windscreen device 7, as a result of changing the height position of the windscreen 8, there is no female fixing member that remains being mounted to the vehicle body 2 in spite of being unused. Therefore, in the windscreen device 7 according to the present embodiment, the appearance of the straddle-type vehicle is not deteriorated due to rust of the threaded hole of the nut which is not used for fixing the windscreen, as in the above-described remount type height-variable structure in which the nut is fixed to the windscreen mounting portion in advance.

The windscreen device 7 according to the present embodiment has a smaller number of components than the above-described moving operation type height-variable structure including a mechanism that slidably supports a windscreen on a vehicle body and a lock mechanism that locks the windscreen, and the above-described moving operation type height-variable structure including a motor for moving a windscreen in an upper-lower direction and an operation switch for operating the motor. Therefore, with the windscreen device 7 according to the present embodiment, the number of components of the windscreen device 7 can be reduced, the windscreen device 7 can be manufactured at low cost, and the windscreen device 7 can be easily reduced in size and weight.

In the windscreen device 7 according to the present embodiment, the locking holes 41 to 43 are formed in the mounting member 21, and the insertion type locked portion 58 of the holding member 51 is inserted into any locking hole of the locking holes 41 to 43, so that the holding member 51 is located and locked at any locking position of the first locking position, the second locking position, and the third locking position as illustrated in FIGS. 9A to 9C. With this configuration, the user can easily and accurately align the position of one female fixing member 47 with the position of the upper mounting hole 32 and can easily and accurately align the position of the other female fixing member 48 with the position of the lower mounting hole 34 at the time of mounting the windscreen 8 removed from the mounting member 21 to the mounting member 21 again during the work of changing the height position of the windscreen 8 from, for example, the first height position P1 to the second height position P2. Accordingly, the workability of the work of changing the height position of the windscreen 8 can be improved.

In the windscreen device 7 according to the present embodiment, the insertion type locked portion 58 is inserted into any locking hole of the locking holes 41 to 43, so that the holding member 51 is locked to the edge portion of the mounting plate 22 on one side in the left-right direction in a substantial view, and each of the hanging type locked portions 61 and 62 sandwiches the edge portion of the mounting plate 22 on the other side in the left-right direction, so that the holding member 51 is locked to the edge portion on the other side in the left-right direction of the mounting plate 22. In this way, by locking the holding member 51 to the portions of the mounting plate 22 on both sides in the left-right direction, it is possible to make it difficult for the holding member 51 to fall off from the mounting member 21. Therefore, when the female fixing members 47 and 48 are held on the mounting plate 22 by the holding member 51, the stability of the holding can be enhanced.

With the windscreen device 7 according to the present embodiment, the user can easily remove and separate the holding member 51 from the mounting member 21, as illustrated in FIGS. 8A to 8E. Therefore, the workability of the work of changing the height position of the windscreen 8 can be improved.

The holding member 51 includes the stop 59. After the male fixing members 45 are removed from the female fixing members 47 and 48, respectively, the holding member 51 is temporarily fixed to the mounting member 21 by the stop 59. Accordingly, the holding member 51 can be prevented from falling off the mounting member 21.

In the windscreen device 7 according to the present embodiment, the two female fixing members 47 and 48 are coupled to each other by the coupling portion 55 of the holding member 51 in each of the mounting mechanisms 17 and 18. With this configuration, in the work of changing the height position of the windscreen 8, the user can align the positions of the two female fixing members 47 and 48 with the position of the upper mounting hole 31 and the position of the lower mounting hole 34 at a time only by locking the holding member 51 to the mounting member 21 to be at the first locking position, for example. In addition, for example, the user can move the two female fixing members 47 and 48 from the positions facing the upper mounting hole 31 and the lower mounting hole 34, respectively, to the positions facing the upper mounting hole 32 and the lower mounting hole 35, respectively, at a time only by moving the holding member 51 from the first locking position to the second locking position. Therefore, the work of changing the height position of the windscreen 8 can be facilitated, and the workability can be improved.

The straddle-type vehicle 1 according to the embodiment of the present invention includes the windscreen device 7, and thus has an effect of improving the workability of the work of changing the height position of the windscreen 8, an effect of preventing the appearance of the straddle-type vehicle 1 from being deteriorated due to rust of the threaded hole of the nut which is not used for fixing the windscreen, and an effect of reducing the number of components to reduce the manufacturing cost of the straddle-type vehicle 1 and easily reduce in size and weight of the straddle-type vehicle 1.

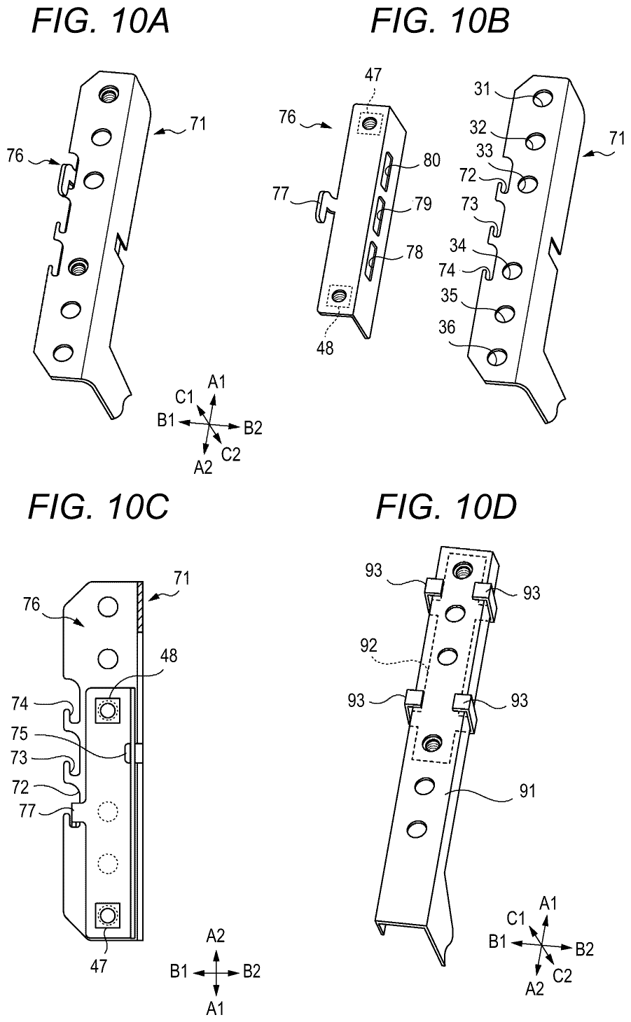

A locking structure between the mounting member 21 and the holding member 51 in the above-described embodiment may be changed to, for example, the structure illustrated in FIGS. 10A to 10C. That is, three locking recesses 72, 73, and 74 are provided in a portion of the mounting member 71 on the arrow B1 direction side, as illustrated in FIG. 10B. As illustrated in FIG. 10C, a locking protrusion 75 is provided at a portion of the mounting member 71 on the arrow B2 direction side. As illustrated in FIG. 10B, a hook-shaped locked portion 77 is provided at a portion of the holding member 76 on the arrow B1 direction side. As illustrated in FIG. 10B, three locked holes 78, 79, and 80 are provided in a portion of the holding member 76 on the arrow B2 direction side. The locked hole 78 of the holding member 76 is locked to the locking protrusion 75 of the mounting member 71 and the hook-shaped locked portion 77 of the holding member 76 is locked to the locking recess 72 of the mounting member 71, so that the holding member 76 is locked at the first locking position of the mounting member 71 as illustrated in FIGS. 10A and 10C. The locked hole 79 of the holding member 76 is locked to the locking protrusion 75 of the mounting member 71 and the hook-shaped locked portion 77 of the holding member 76 is locked to the locking recess 73 of the mounting member 71, so that the holding member 76 is locked at the second locking position of the mounting member 71. The locked hole 80 of the holding member 76 is locked to the locking protrusion 75 of the mounting member 71 and the hook-shaped locked portion 77 of the holding member 76 is locked to the locking recessed 74 of the mounting member 71, so that the holding member 76 is locked at the third locking position of the mounting member 71.

The locking structure between the mounting member 21 and the holding member 51 in the above-described embodiment may be changed to, for example, the structure illustrated in FIG. 10D. In FIG. 10D, the holding member 92 is provided with four hanging type locked portions 93, and the holding member 92 is locked to edge portions of the mounting member 91 on both sides in the arrow B1-B2 direction (left-right direction) by the four hanging type locked portions 93. The holding member 92 can slide in the arrow A1-A2 direction.

In the above-described embodiment, the windscreen device 7 in which the height position of the windscreen 8 can be changed in three stages is taken as an example, but the present invention is not limited thereto. By changing the number of mounting holes and the number of locking holes in the mounting member 21, the height position of the windscreen 8 may be changed in two stages, or four or more stages.

In the above-described embodiment, a case where two portions of the windscreen 8 on one side in the left-right direction are fixed to the mounting member 21 of the mounting mechanism 17 and two portions of the windscreen 8 on the other side in the left-right direction are fixed to the mounting member 21 of the mounting mechanism 18 is taken as an example, but the present invention is not limited thereto. One portion or three or more portions of the windscreen 8 on one side in the left-right direction may be fixed to the mounting member 21 of the mounting mechanism 17, and one portion or three or more portions of the windscreen 8 on the other side in the left-right direction may be fixed to the mounting member 21 of the mounting mechanism 18.

In the above-described embodiment, a case where the mounting member 21 is erected above the front cover 3 is taken as an example, but the present invention is not limited thereto. The mounting member may be formed on, for example, a part of a front cover, a front cowl, or a meter visor.

In the above-described embodiment, a case where a bolt is used as the male fixing member and a nut is used as the female fixing member is taken as an example, but the present invention is not limited thereto. As the male fixing member, a stopper such as a pin, a clip, or a rivet can be used, and as the female fixing member, a stopper coupled to such a stopper can be used.

A straddle-type vehicle provided with the windscreen device according to the present invention and a type of the straddle-type vehicle according to the present invention are not limited. The present invention can be applied not only to a motorcycle of an adventure type but also to a motorcycle of a sports type, can be applied to a scooter, and can be applied to a three-wheeled vehicle or a buggy car.

The present invention can be appropriately changed without departing from the gist or concept of the invention which can be read from the claims and the entire description, and a windscreen device and a straddle-type vehicle accompanied with such a change are also included in the technical concept of the present invention.

What is claimed is:

1. A windscreen device comprising:
a windscreen provided with a pair of left and right insertion holes; and
a pair of left and right mounting mechanisms configured to mount the windscreen to a vehicle body, wherein
each of the mounting mechanisms includes
a mounting member provided on the vehicle body and including a mounting plate which extends upward while being inclined rearward and extends in a left-right direction,
a male fixing member,
a female fixing member coupled to the male fixing member, and
a holding member configured to hold the female fixing member on a rear surface side of the mounting plate,
the mounting plate is provided with a first mounting hole and a second mounting hole having different height positions,
the male fixing member is inserted into one insertion hole of the pair of insertion holes, then inserted into one mounting hole of the first mounting hole and the second mounting hole, and then coupled to the female fixing member, so that the windscreen is fixed to the mounting member, and
the female fixing member is held on the mounting member by the holding member to be movable between a position facing the first mounting hole and a position facing the second mounting hole.

2. The windscreen device according to claim 1, wherein
in each of the mounting mechanisms,
the mounting member includes a first locking portion configured to lock the holding member so that the female fixing member is located at the position facing the first mounting hole, and a second locking portion configured to lock the holding member so that the female fixing member is located at the position facing the second mounting hole.

3. The windscreen device according to claim 1, wherein
in each of the mounting mechanisms,
the holding member includes two locked portions,
one locked portion of the two locked portions is locked to an edge portion of the mounting plate on one side in the left-right direction, and another locked portion of the two locked portions is locked to the edge portion of the mounting plate on the other side in the left-right direction.

4. The windscreen device according to claim 2, wherein
in each of the mounting mechanisms,
the mounting member includes a locking plate extending rearward while being inclined downward from an edge portion of the mounting plate on one side in the left-right direction,
the locking plate are provided with holes which are respectively the first locking portion and the second locking portion,
the holding member includes a base portion to which the female fixing member is fixed and which is disposed on the rear surface side of the mounting plate, and two locked portions,
one locked portion of the two locked portions extends from the base portion to one side in the left-right direction, and is inserted into one locking portion of the first locking portion and the second locking portion to be locked to the one locking portion, and
the other locked portion of the two locked portions extends to one side in the left-right direction after extending to a front side while being inclined upward from the base portion, and is locked to the edge portion on the other side in the left-right direction of the mounting plate.

5. The windscreen device according to claim 1, wherein
the pair of left and right insertion holes are respectively provided in an upper portion and a lower portion of the windscreen,
each of the mounting mechanisms includes two male fixing members and two female fixing members, and
in each of the mounting mechanisms,
two first mounting hole are respectively provided in an upper portion and a lower portion of the mounting plate,
two second mounting holes are respectively provided the upper portion and the lower portion of the mounting plate,
one of the first mounting holes provided in the upper portion of the mounting plate and one of the second mounting holes provided in the upper portion of the mounting plate have different height positions,
the holding member includes a coupling portion configured to couple the two female fixing members to each other, holds one female fixing member of the two female fixing members on a rear surface side of the upper portion of the mounting plate, and holds the other female fixing member on a rear surface side of the lower portion of the mounting plate, and
a distance between the pair of insertion holes provided in the upper portion of the windscreen and the pair of insertion holes provided in the lower portion of the windscreen, a distance between the one of the first mounting holes provided in the upper portion of the mounting plate and another one of the first mounting holes provided in the lower portion of the mounting plate, a distance between the one of the second mounting holes provided in the upper portion of the mounting plate and another one of the second mounting holes provided in the lower portion of the mounting plate, and a distance between the two female fixing members which are coupled to each other by the coupling portion are equal to one another.

6. A straddle-type vehicle comprising
a windscreen device; and
a vehicle body, wherein
the windscreen device including:
a windscreen provided with a pair of left and right insertion holes; and
a pair of left and right mounting mechanisms configured to mount the windscreen to the vehicle body,
each of the mounting mechanisms includes:
a mounting member provided on the vehicle body and including a mounting plate which extends upward while being inclined rearward and extends in a left-right direction,
a male fixing member,
a female fixing member coupled to the male fixing member, and
a holding member configured to hold the female fixing member on a rear surface side of the mounting plate,
the mounting plate is provided with a first mounting hole and a second mounting hole having different height positions,
the male fixing member is inserted into one insertion hole of the pair of insertion holes, then inserted into one mounting hole of the first mounting hole and the second mounting hole, and then coupled to the female fixing member, so that the windscreen is fixed to the mounting member, and
the female fixing member is held on the mounting member by the holding member to be movable between a position facing the first mounting hole and a position facing the second mounting hole.
